(19) United States
(12) Patent Application Publication
(10) Pub. No.: US 2020/0238579 A1
(43) Pub. Date: Jul. 30, 2020

(54) PROCESS FOR THE PRODUCTION OF HOLLOW PLASTIC ARTICLES BY ROTATIONAL MOLDING POLYMERIC COMPOUNDS IN A ROTOMOLD

(71) Applicant: Merck Patent GmbH, Darmstadt (DE)

(72) Inventor: Scott AUMANN, Indian Harbour Beach, FL (US)

(73) Assignee: Merck Patent GmbH, Darmstadt (DE)

(21) Appl. No.: 16/062,851

(22) PCT Filed: Nov. 21, 2016
(86) PCT No.: PCT/EP2016/001956

§ 371 Date: Jun. 15, 2018

Related U.S. Application Data
(60) Provisional application No. 62/269,550, filed on Dec. 18, 2015.

(51) Int. Cl. B29C 41/04; B29C 37/00; B29C 41/08; B29C 41/22; B29C 41/00

(52) U.S. Cl. CPC B29C 41/04; B29C 37/0028; B29C 41/08; B29K 2023/0641; B29C 41/003; B29C 2037/0039; B29C 41/22

(57) ABSTRACT

The present invention relates to a process for the production of hollow plastic articles in a rotational molding process as well as to hollow plastic articles made by such a process, in particular to a process for the production of hollow plastic articles which exhibit a colored surface exhibiting striking pearlescent or metallic effects.

The present invention relates to a process for the production of hollow plastic articles in a rotational molding process as well as to hollow plastic articles made by such a process. In particular, the present invention relates to a process for the production of hollow plastic articles which exhibit a smooth and evenly colored surface exhibiting striking pearlescent or metallic effects without any visible optical disruptions, flow or welding lines or pigment aggregations.

Rotational casting or molding processes, which are also called rotomolding processes, for the production of hollow plastic articles of different kinds are very well known in the art. They are very attractive and applicable in an economic manner for the production of hollow plastic articles for divers applications, e.g. as tanks, for transportation, as containers, as toys and leisure articles, for materials handling, in the marine industry, for medical or industrial products, etc. In particular the production of large and very large vessels and the production of hollow articles with complex three-dimensional shapes is possible under high quality standards.

In a typical rotomolding process as known in the art, a known amount of a polymeric compound which may be in powder, granular or liquid form is charged into a hollow, shell-like mold (rotomold). The mold is then heated and simultaneously rotated about two principal axes so that the polymeric compound enclosed in the mold adheres to the inner mold surface and forms a plastic layer thereon. The mold rotation continues during the cooling phase which follows the heating phase so that the plastic layer achieved on the inner surface of the mold retains the desired shape as it solidifies. When the plastic is sufficiently rigid, the mold rotation is stopped and the plastic product may be removed from the mold. The process is executed under a relatively low rotational speed of about 4 to 20 revs/min. Several types of machines bearing the molds may be used, which allow the production steps of mold charching, mold heating, mold cooling and part ejection to be executed simultaneously with different molds in different zones or one by one with more than one mold at a time. In addition, the motion in two principal axes may be completed by a “Rock and Roll” motion as well.

Usually a rotomold is composed of two parts which are clamped together to form the hollow rotomold when the rotomolding process is executed, but rotomolds which are composed of three or more parts may also be used. Rotomolds with relatively thin wall thickness are possible, since the rotational molding process is, in most cases, executed under atmospheric pressure or, in exceptional cases, under only small pressure or vacuum.

The rotomolding process allows the production of hollow plastic articles with uniform wall thickness, having neither pinch-off seams nor welding lines. This holds true for the production of natural colored rotomolded parts as well as for the production of colored rotomolded parts which are colored by means of small sized, powdered pigments which are mostly of inorganic composition. These pigments may be dry blended with a polymeric compound powder or may be compounded with a polymeric compound and then ground to achieve the desired powder size of about 35 mesh. Alternatively, the pigments may be dispersed in a liquid polymeric starting material, whereby often plastisols are used.

Nevertheless, in case that platelet-shaped effect pigments shall be used in order to create metallic or pearlescent effects on the surface of the desired plastic parts, some obstacles occur which are due to the different chemical and physical nature of the polymeric compounds and of the effect pigments used. Platelet-shaped effect pigments are usually composed of inorganic materials and exhibit in most cases a very low bulk density so that, when a dry blend of platelet-shaped effect pigments and of a polymeric powder is used as a starting material in a rotomolding process, the platelet-shaped effect pigments may not be distributed evenly in the blend, although the latter was properly mixed prior to use. Due to their low bulk density, they tend to float on the surface of the charged polymer powder pool prior to achieving the right softening temperature of the polymeric powder. Even if the platelet shaped effect pigments do have direct contact with the heated wall in the further procedure, they tend to fall back into the inner hole, since they do not stick actively on the wall, but merely if attached to the softened polymeric compound. In addition, due to their platelet shape and relatively large size of up to 200 micrometers, the effect pigments orient themselves randomly in the plastic layer built on the inner surface of the mold and concentrate on the inner surface of the plastic layer rather than on the outer surface thereof, the latter creating the outer visible surface of the produced hollow plastic part in the end.

The low concentration of platelet-shaped effect pigments on the outer surface of the produced plastic part as well as their poor orientation along that surface leads to merely weak optical effects of the platelet-shaped effect pigments if used. Therefore, platelet-shaped effect pigments such as metal pigments or pearlescent pigments have rarely been used in rotomolding processes in the last decades.

Somewhat better results were achieved when precompounded raw materials of polymeric compound(s) and platelet-shaped effect pigments were used, but there is still a need to provide a rotomolding process where striking optical effects due to the use of platelet-shaped effect pigments may be achieved. To this end, a high enough concentration of these effect pigments on the outer surface of the resulting rotomolded plastic part as well as a good parallel orientation of the effect pigments along this outer surface is needed.

In U.S. Pat. No. 3,079,644, a method of making decorated plastic articles is described, wherein decorative play balls are made by a rotational casting method, wherein preformed plastisols of one or more colors are distributed in a pattern and gelled on the inner surface of a rotomold, followed by charging a further plastisol of a different color into the rotomold and executing a rotomolding process without destroying the pattern formed by the first plastisol on the mold wall.

By this method, patterned play balls exhibiting two or more colors on their surface are achieved. This process is limited to the use of plastisols and to the production of play balls. Neither the production of large vessels having complex shapes nor the use of platelet-shaped effect pigments is mentioned.

In U.S. Pat. No. 4,238,537 a process for the rotational molding of hollow articles is disclosed, which does also belong to the production of play balls or sports balls, needing good “bounce” characteristics over a long time period. The process is directed to the combined use of pellets and powder, both of ethylene vinyl acetate copolymers, in a usual rotomolding process. The process conditions are such that the EVA pellets remain substantially in shape after the rotomolding process is executed and that the EVA powder simply fills the voids between the pellets. Both, powder and pellets, may contain metallic flitter particles which are at least 3 fold the size of commonly used platelet-shaped effect pigments and need precoatings of epoxy resins on their surface in order to stand the process.

DE 10 2012 218 858 A1 as well is directed to the production of plastic balls by a rotomolding process. Here, a ball precursor is formed by using a polymer composition which is advantageously in the form of a paste or plastisol in a usual rotomolding process, wherein the polymer composition comprises effect pigments, in particular metal effect pigments or pearlescent pigments. After executing the rotomolding process, the ball precursor is blown up and printed with a pattern using a colored printing ink, occasionally followed by a further blow up process step. At least at some parts of the surface of the resulting ball, the printing ink is light transparent, thereby allowing the metallic or pearlescent effect of the raw ball shimmering through. The problem of inhomogeneous distribution of the effect pigments in the polymeric starting material is addressed by suggesting heating the polymeric starting material composition to a liquid or pasty state prior to mixing the effect pigments into it in order to avoid settling or floating of the effect pigments therein. A “riping period” for the polymeric starting composition containing the pigments of up to 24 hours is suggested.

The prior art references are either not directed to the use of commonly used platelet shaped effect pigments in usual rotomolding processes for the production of optically attractive hollow articles or do simply suggest a preheating step of the starting polymeric material in order to achieve a homogeneous distribution of such platelet-shaped effect pigments in the resulting product. Such a preheating step requires a long preparation time period combined with high energy cost and does merely allow the use of pasty or liquid starting materials for the rotomolding procedure. Since, for larger products than balls, the amount of starting materials and, thus, the energy cost for preheating the starting material bulk would rise significantly, this method may not be used for the production of large and very large hollow plastic articles, in particular for industrial purposes.

Therefore, it is the object of the present invention to provide a rotomolding process for the production of hollow plastic parts of any kind which results in desirable hollow plastic parts exhibiting striking visual metallic effects or pearlescent effects on the surface thereof, whereby no visible irregularities, optical disruptions, flow or welding lines or pigment aggregations occur, whereby the process may be executed in an economic manner using machinery and divers starting materials already known and used in the art.

In addition, it is a further object of the present invention to provide hollow plastic articles exhibiting striking visual metallic or pearlescent effects on the outer surfaces thereof, whereby these hollow plastic articles are substantially produced by a known rotomolding process.

The object of the present invention is solved by a process for the production of hollow plastic articles by rotational molding polymeric compounds in a rotomold, whereby the following steps are executed in sequence:
A) forming a colored outer shell of a hollow plastic article in a stationery open rotomold having an inner surface, by applying a colored polymer particulate composition comprising a first polymer and coloring pigments to the inner surface of the rotomold,
B) charging a rotomolding polymer composition comprising a second polymer into the rotomold,
C) closing the rotomold, and
D) processing a rotomolding procedure by rotating the rotomold, thereby forming an inner layer of the hollow plastic article.

In addition, the object of the present invention is also achieved by a hollow plastic article being composed of a colored outer shell and an inner layer which are inseparably connected to each other, wherein the hollow plastic article is produced by a process according to the process mentioned above.

In the process according to the present invention, a usual hollow rotomold is used, who's inner shape depends on the desired outer shape of the resulting hollow plastic article. The rotomold may be composed of two parts or of three or more parts, depending on the complexity of the desired end product's shape, whereby rotomolds composed of two parts are preferred. Rotomolds comprising vents are usually used in the art and are preferably used in the process according to the present invention too.

In step A) of the process according to the present invention, a stationary rotomold is used, which has been opened to an extent that the inner surface of the rotomold is freely accessible. The rotomold is heated by means of any known manner up to a temperature which is equal or above the glass transition temperature of the first polymer.

By applying heat to the rotomold, at least the inner surface of the rotomold is heated until at least the glass transition temperature of the first polymer is achieved.

The rotomold may be heated in total or partly, thereby heating either the whole inner surface of the rotomold or desired parts thereof, the latter may be in the shape of a pattern on the inner surface of the rotomold or may create a pattern when seen in combination with each other.

In case the whole rotomold should be heated, any oven commonly used in the art is applicable. In case that merely targeted areas of the inner surface of the rotomold should be heated, flame treatment of these areas is one possible way to preheat the rotomold.

The rotomold is heated until the inner surface thereof, in total or partly, as the case may be, exhibits a temperature in the range of from 100 to 400° C., preferably of from 150 to 350° C. and in particular of from 200 to 350° C. As already mentioned above, the actual temperature depends on the polymer compound(s) used in step A) and must at least achieve at the glass transition temperature thereof.

Following heating of the rotomold, a colored polymer particulate composition is applied to the hot inner surface of the rotomold. The colored polymer particulate composition is composed at least of a first polymer and of coloring pigments.

For the first polymer, any polymer compound applicable to rotomolding processes may be used. Usually, thermoplastic polymers are of advantage, although some thermosetting polymer materials may also be used.

Useful polymer materials for the first polymer are polyethylenes of different kind (LLDPE, HDPE, XLPE, MDPE, LDPE), also polyvinylchloride (PVC) as well as other polymers such as polycarbonates, nylons, polypropylenes, unsaturated polyesters, ABS, acryl polymers, polybutylenes, polystyrenes, polyurethanes, epoxy resins, fluorocarbons and phenolic resins. Polyethylenes of the kinds mentioned as well as polyvinylchlorides are preferred. Polyethylenes are especially preferred. The first polymer may be composed of a single polymer compound, of a copolymer or of a mixture of two or more polymer compounds selected from those mentioned above.

The first polymer in step A) is advantageously applied as a powder. To this end, the first polymer may be used as available in powdery form on the market. No additional milling or grinding process is needed then. Usually, the grain size of the polymer powder particles used is in the range of from 1 to 100 μm, in particular in the range of from 30 to 50 μm.

In addition to the first polymer, the colored polymer particulate composition in step A) does also contain coloring pigments of at least one type. Preferably, the coloring pigments comprise at least one type of platelet-shaped effect pigments. Platelet-shaped effect pigments which may be used in the process according to the present invention are taken to mean platelet-shaped pearlescent pigments, platelet-shaped interference pigments which are either predominantly transparent or semi-transparent, and platelet-shaped metal effect pigments.

These platelet-shaped pigments are built up from one or more layers of materials, which may be different if desired.

Pearlescent pigments consist of transparent flakes of high refractive index and exhibit a characteristic pearlescence on parallel alignment due to multiple reflection. Pearlescent pigments of this type which additionally also exhibit interference colours are known as interference pigments.

Although classical pearlescent pigments, such as TiO₂ flakes, basic lead carbonate, BiOCI pigments or nacreous pigments, are of course in principle also suitable, the platelet-shaped effect pigments preferably employed for the purposes of the present invention are interference pigments or metal effect pigments which have at least one coating of a metal, metal oxide, metal oxide hydrate or mixtures thereof, a metal mixed oxide, metal suboxide, metal oxynitride, metal fluoride, BiOCI or of a polymer on an inorganic flake-form support. The metal effect pigments preferably have at least one metal layer. The inorganic flake-form support preferably consists of natural or synthetic mica, kaolin or other phyllosilicates, of glass, SiO₂, TiO₂, Al₂O₃, Fe₂O₃, graphite flakes or of metal flakes, such as, for example, of aluminium, titanium, bronze, silver, copper, gold, steel or various metal alloys.

Particular preference is given to supports of mica, glass, graphite, SiO₂, TiO₂ and Al₂O₃ or mixtures thereof.

The size of these substrates is not crucial per se. The substrates generally have a thickness of between 0.01 and 5 μm, in particular between 0.05 and 4.5 μm. The extension in the length or width is usually between 1 and 200 μm, preferably between 2 and 200 μm and in particular between 2 and 100 μm, mostly preferred between 10 and 80 μm. They generally have an aspect ratio (ratio of the average diameter to the average particle thickness) of 2:1 to 2,000:1 and in particular 3:1 to 200:1.

A coating applied to the support preferably consists of metals, metal oxides, metal mixed oxides, metal suboxides or metal fluorides and in particular of a colourless or coloured metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Coatings of metals preferably comprise aluminium, titanium, chromium, nickel, silver, zinc, molybdenum, tantalum, tungsten, palladium, copper, gold, platinum or alloys thereof.

The metal fluoride employed is preferably MgF₂.

The platelet-shaped effect pigments employed are particularly preferably multilayered effect pigments. These have a plurality of layers, which preferably consist of the above-mentioned materials and have various refractive indices in such a way that in each case at least two layers of different refractive index alternate on the support, on a flake-form, preferably non-metallic support, where the refractive indices in the individual layers differ by at least 0.1 and preferably by at least 0.3. The layers located on the support can be either virtually transparent or coloured or semitransparent.

The platelet-shaped effect pigments described above may be present individually or in a mixture in the colored polymer particulate composition used in step A) in accordance with the present invention.

The platelet-shaped effect pigments employed in accordance with the present invention may be transparent or semitransparent, i.e. they may transmit at least 10% of the incident light.

Furthermore, platelet-shaped metal effect pigments which are either composed of a single opaque metal layer or contain at least one opaque metal layer may also be used. For these opaque platelet-shaped pigments, transmittance of the incident light is less than 10%.

Both types of platelet-shaped effect pigments may be used as single pigment types or in combination with each other, whereby combinations of several types of transparent or semi-transparent platelet-shaped pigments with each other are as possible as combinations of several types of opaque metal platelet-shaped pigments or mixtures of transparent or semi-transparent platelet-shaped pigments with opaque metal platelet-shaped pigments. The actual use of pigment types depends on the desired optical effects on the surface of the resulting hollow articles to be produced.

Platelet-shaped effect pigments that can be employed are, for example, the commercially available interference pigments available under the names Iriodin®, Colorstream®, Xirallic® from Merck KGaA, Mearlin® from Mearl, metal-effect pigments from Eckhard and goniochromatic (optically variable) effect pigments, such as, for example, Variochrom® from BASF, Chromafflair® from Flex Products Inc., and other commercially available pigments of the same type. However, this list should merely be regarded as illustrative and not restrictive.

Alternatively or, preferably, in addition to the platelet-shaped effect pigments, the colored polymer particulate composition may also comprise further coloring pigments which are not platelet-shaped. These coloring pigments may be composed of inorganic or organic colored compounds. Inorganic colored pigments are preferred, although organic pigments, which sustain the temperature of the application procedure without being decomposed, are also applicable.

Suitable inorganic colored pigments are all customary transparent and opaque white, coloured and black pigments, such as, for example, Berlin Blue, bismuth vanadate, goethite, magnetite, haematite, chromium oxide, chromium hydroxide, cobalt aluminate, ultramarine, chromium/iron mixed oxides, spinels, such as Thenard's Blue, cadmium sulfides and selenides, chromate pigments or carbon black, while organic colored pigments which may be mentioned are, in particular, quinacridones, benzimidazoles, copper phthalocyanine, azo pigments, perinones, anthanthrones, further phthalocyanines, anthraquinones, indigo, thioindigo and derivatives thereof, or Carmine Red.

The particle size of the inorganic and organic coloured pigments is not limited, but must be matched to the requirements of the application process for step A) as described later.

In addition or alternative to the further, non platelet-shaped coloring pigments, the colored polymer particulate composition used in step A) may also comprise further additives. These may comprise flow-control additives, anti-cratering and levelling additives, matting additives, UV-stabilizers, scratch or abrasion resistance enhancers, fluidization enhancers, etc.

The colored polymer particulate composition may be used in the form of a dry blend of all (solid) ingredients. Since this is the simplest form of application, it is preferably used. To this end, the first polymer may be used in the form of a polymer powder which is commercially available. All the other ingredients, in particular the platelet-shaped effect pigments and, alternatively or optionally in addition, also the further, non platelet-shaped coloring pigments and or further solid additives, may be simply mixed in order to achieve at a dry blend.

The colored polymer particulate composition may also be used in the form of a premixed and extruded composition of all desired ingredients being ground after extrusion to achieve at a particulate solid mixture having particle sizes in the range of from about 10 μm to about 200 μm. Such a composition allows the use of some liquid additives prior to mixing and extrusion.

Alternatively, a polymer composition containing the at least one polymer compound and optionally additives and coloring pigments other than platelet-shaped effect pigments may be mixed with the platelet-shaped effect pigments by means of a so-called bonding process which is often used in preparing common powder coating compositions.

The particle size of the particles of the colored polymer particulate composition according to the present invention is usually in the range of from 1 to 200 μm, in particular of from 10 to 150 μm and especially of from 15 to 100 μm. In case of using a dry blend of solid ingredients as explained above, the particle size of the different ingredients is, of course, different from each other.

According to the present invention, the colored polymer particulate composition is applied to the inner surface of the pre-heated stationary rotomold by means of a spraying process. According to the invention, the spraying process is preferably executed by a powder coating step, using a powder coating gun.

Unlike usual powder coating procedures, the powder coating step according to the present invention does not necessarily need to take place onto an electrically conducting surface, but on the simply pre-heated inner surface of an open, stationary rotomold instead. Nevertheless, all powder coating guns of several types, which may be used in common powder coating processes, may be used here as well. In particular, Corona powder coating guns are preferred. For example, standard powder coating guns of Wagner Systems, Inc., of Nordson Corporation or of Gema Switzerland GmbH may be used, to name only a few.

In case that the stationary rotomold may not be inserted into any oven due to several reasons, pre-heating and coating in step A) may also be executed for example by means of a flame powder coater, which is a piece of equipment combining a flame torch and a powder coating gun, being applied in turn of each other when the inner surface of the rotomold is coated.

When the polymer compound(s) of the colored polymer particulate composition arrive at the pre-heated inner surface of the rotomold, they stick to the surface and melt, building a thin polymer layer thereon. Since the platelet-shaped effect pigments as well as the other solid ingredients contained in the colored polymer particulate composition are applied to the inner surface of the pre-heated rotomold with the same high velocity as the polymer compound(s), they immediately stick to the softened polymer compound(s) and adhere to the inner surface of the pre-heated rotomold as well. Astonishingly, the platelet-shaped effect pigments are even in a position to orient themselves parallel to the inner surface of the rotomold, obviously also based on the high velocity of their application to this surface.

By applying the colored polymer particulate composition according to step A), it is preferred to cover the flanges of the rotomold parts (flanges are the edges of the mold parts that make the parting surface, in most cases of the halves of the rotomold). They may be covered by masks or tapes or by other appropriate means.

By cooling and solidifying the resulting polymer and effect pigments containing layer, the colored polymer particulate composition applied in step A) according to the present invention forms a colored polymer outer shell of the desired hollow plastic article on the inner surface of the rotomold. This colored outer shell exhibits a thickness in the range of from 300 μm to 50 mm, in particular of from 500 μm to 20 mm.

The thickness of the coloring outer shell, based on the overall thickness of the final hollow plastic product, is 5 to 95%, in particular 10 to 80%. This outer shell may be supposed to the further process steps B) to D) immediately after step A) took place or may be removed from the inner surface of the rotomold and supposed to further processing at a later point of time.

After the colored outer shell of the desired plastic article has been produced in step A), the rotomold is charged with a rotomolding polymer composition comprising a second polymer according to step B).

The second polymer may be a single polymer compound or a mixture and/or copolymer of several polymer compounds.

Useful polymer compounds are selected from the group of polyethylenes of different kind (LLDPE, HDPE, XLPE, MDPE, LDPE), polyvinylchloride (PVC), polycarbonates, nylons, polypropylenes, unsaturated polyesters, ABS, acryl polymers, polybutylenes, polystyrenes, polyurethanes, epoxy resins, fluorocarbons and phenolic resins. Polyethylenes of the kinds mentioned as well as polyvinylchlorides are preferred. Polyethylenes are especially preferred.

The first polymer and the second polymer may be of a different or of the same chemical composition. Preferably, they are of the same chemical composition.

The rotomolding polymer composition used in step B) may, besides the second polymer, contain coloring pigments as well as additives, similar to the colored polymer particulate composition used in step A).

The use of platelet-shaped effect pigments in the rotomolding polymer composition for step B) is possible, although not of advantage. Therefore, it is preferred that the rotomolding polymer composition in step B) does not contain platelet-shaped effect pigments. Coloring pigments other than platelet-shaped effect pigments may be used. They may exhibit the same color as the non platelet-shaped coloring pigments used in step A) or may be of a different color, or may be contained in the rotomolding polymer composition of step B) but not in the colored polymer particulate composition of step A).

By choosing the non platelet-shaped coloring pigments in the polymer compositions in step A) and B), interesting coloring effects in addition to the optical effect which is due to the platelet-shaped effect pigments in the outer shell of the hollow plastic article may be achieved.

Additives which may be used in the rotomolding polymer composition in step B) are those which are usually used in common rotomolding compositions. Examples are sintering enhancers, UV stabilizers, antioxidants, stabilizers, densification agents and lubricants.

Contrary to the particulate colored polymer composition in step A) the rotomolding polymer composition used in step B) is not requested to be in particulate form. Therefore, even plastisols or other liquid or pasty forms of polymer compositions are applicable.

In case the rotomolding polymer composition used in step B) is in particulate form, the polymer powder particles exhibit grain sizes in the range of from about 60 to 500 μm.

After the rotomolding polymer composition containing the second polymer has been charged into the rotomold, it is closed in step C) as usually done in a common rotomolding process. Prior to closing the rotomold, the coverings on the flanges are removed if necessary. After the rotomold has been closed, the parts thereof are fastened together by means of clamps, bolts or other appropriate means.

After closing the rotomold, a common rotomolding procedure is executed in step D) of the present process. The procedure comprises the heating and rotating of the rotomold as usual (and as described in general above) as well as the cooling step when the desired layer thickness of the inner layer of the hollow plastic article, which is formed in step D), is achieved. The heating of the rotomold is also executed as usual, leading to a rise in temperature of the inner wall of the rotomold as well as of the colored outer shell of the hollow plastic article applied thereto. In addition, the charged rotomolding polymer composition is heated up to at least the glass transition temperature thereof. Advantageously, the rotomolding polymer composition is heated to a temperature greater than the glass transition temperature thereof, i.e. to the melting temperature of the second polymer contained in the rotomolding polymer composition. The actual temperature depends on the polymer compound(s) used and is usually in the range of from of from 100 to 400° C., preferably of from 150 to 350° C. and in particular of from 200 to 350° C.

Since step D) is carried out at a temperature of the rotomold and its content at or above the glass transition temperature of the second polymer, the second polymer is applied in a softened or even molten form to the colored outer, platelet-shaped effect pigments containing shell on the inner surface of the rotomold. Depending on the polymer compound(s) used for the first polymer, the colored outer shell of the hollow plastic article is softened as well while executing the usual rotomolding procedure in step D). The softened second polymer compound as well as the further ingredients which are dragged along the polymer compound during rotation stick to the inner surface of the colored outer shell and form the inner layer of the hollow plastic article there upon cooling thereof.

The layer thickness of the inner layer of the rotomold depends on the amount of the rotomolding polymer composition charged in step B) which is chosen according to the desired purpose of the resulting hollow plastic article. Depending on the actual shape of the hollow plastic article to be produced, the layer thickness of the inner layer thereof may be equal or different at different points of the article. Amounts of ingredients as well as their nature are chosen as usual in rotomolding processes in present step B).

Furthermore, the cooling step too takes place as usual in rotomolding procedures and is executed until the temperature reaches a value which allows ejection or removal of the hollow plastic article.

After the cooling step is executed while maintaining the rotation movement of the rotomold, the rotomold is opened and the resulting hollow article may be ejected or otherwise removed from the rotomold.

Merely for the purpose of completeness it shall be mentioned that step D) may be repeated one or even several times by using different polymer compounds in each step, thereby forming a multi-layered (three or more layers) hollow plastic article. To this end, any intermediate cooling step may or may not take place, as the case may be. The production of multi-layered bodies might be of advantage if a hollow plastic article having certain mechanical and/or thermal stability or exhibiting versatile optical and/or functional characteristics has to be produced.

The present invention is also directed to a hollow plastic article being produced by a process as described above.

The hollow plastic article of the present invention is composed of a colored outer shell and of an inner layer which are inseparably connected to each other.

The colored outer shell comprises at least the first polymer as described above and does also preferably comprise platelet-shaped effect pigments. These platelet-shaped effect pigments provide color as well as gloss, combined with metallic effects or pearlescent optical effects, to the exterior surface of the hollow plastic article. In addition to the platelet-shaped effect pigments, the outer shell may also comprise further additives as mentioned before and/or further coloring pigments, which are either of inorganic or of organic nature and not platelet-shaped. Examples thereof have been described earlier.

The inner layer of the hollow plastic article according to the present invention is composed of at least the second polymer, but may also comprise further additives and/or further coloring pigments. Unlike the coloring pigments for the outer shell, the coloring pigments of the inner layer do preferably not comprise platelet-shaped effect pigments, but are composed only of the inorganic or organic coloring pigments mentioned above, which do not exhibit a platelet shape. The coloring pigments contained in the inner layer may exhibit the same or any different color when compared with the further coloring pigments contained in the outer shell. They may also exhibit either the same or any different color when compared with the color of the platelet-shaped effect pigments contained in the outer shell. In addition, only one of the outer shell and the inner layer may comprise further coloring pigments which are not platelet-shaped at all.

By varying content and/or color of the various coloring pigments in the outer shell as well as in the inner layer, very interesting color characteristics of the resulting hollow plastic articles may be achieved, which can also be varied from time to time easily.

Surprisingly, the hollow plastic article which is produced by the process according to the present invention preferably possesses an exterior surface exhibiting striking pearlescent or metallic effects without any visible disruptions, flow or welding lines or pigment aggregations. Since the platelet-shaped effect pigments in the outer shell are homogeneously distributed therein and well oriented parallel to the exterior surface thereof, the optical effects are homogeneous and clearly visible over the entire exterior surface of the hollow article. This holds not only true for metallic or pearlescent effects, but also for a good glossiness as well as for clear and saturated interference colors, if applicable.

The hollow plastic article according to the present invention is taken to mean a tank, a means for transportation, a container, a toy or a leisure article, a product for materials handling, a product for the marine industry, a medical or an industrial product.

In particular, the hollow plastic article of the present invention is a tank, such as a septic tank, an oil tank, a water treatment tank, a chemical storage tank, a fuel tank, a shipping tank, etc., or is a means for transportation, such an instrument panel, a supermarket trolley, an audio housing unit, a traffic sign or barrier, etc., or is a container, such as an airline container, a refrigerator box, a planter, a drum, a shipping container, etc., or is a toy or a leisure article such as a playhouse, a ball, a doll's part, a ride-on-toy, an outdoor furniture, etc., or is a product for materials handling such as a pallet, a trash can, a fish bin or a packaging good, etc., or is a product for the marine industry such as a pool liner, a docking fender, a fish bin or a packaging article, etc., or is a medical product such as a face oxygen mask, a stretcher, a medical specimen case, etc., or is an industrial product such as a floor polisher, a recycling unit, a water filtration unit, etc., or is any further hollow product such as a tool box, a dental chair, an agricultural or garden equipment, etc.

Any product which might be produced by a common rotomolding process may also be produced by the process according to the present invention. By simply adding a single step to the common process, the obstacles which occur when platelet-shaped effect pigments shall be used in order to apply desired optical effects to the exterior surface of the hollow plastic articles may be overcome. The process is simple and does not request a costly or comprehensive additional equipment except a simple powder coating gun. Since the process does also work well by applying a simple dry blend of the starting ingredients in the powder coating step, it is cheap as well as reliable and may be, thus, easily adapted to the rotational molding processes which are commonly used in the art.

In addition, since merely the outer shell of the resulting hollow plastic article must contain a platelet-shaped effect pigment in order to achieve the desired effects created by these effect pigments, the present process leads to products with much better optical effects but less material use than the rotomolding processes using platelet-shaped effect pigments of the prior art. Still furthermore, production cost might be also be reduced by using a second polymer compound for the inner layer which is less cost consuming than the first polymer used for the production of the outer shell.

The process of the present invention is further described in the following examples without being construed to be limited thereto.

### EXAMPLE 1

An open 2 part metal rotomold is pre-heated to a temperature of about 200° C. in a common oven.

A mixture of 5% by weight of a pearl pigment (Iriodin® 305 Solar Gold, Product of Merck KGaA, Germany), 0.2% by weight of an inorganic coloring pigment (Phthalocyanine Blue, product of Clariant, Germany) and 94.8% by weight of a standard polyethylene powder is dry blended and filled into a standard powder coating gun.

Both halves of the hot rotomold are removed from the oven and hung in a powder coating spray booth. A mask or a tape is applied onto the flanges of the open halves of the rotomold.

Afterwards, the inside surface of the pre-heated rotomold halves is sprayed by means of the powder coating gun as long as the rotomold halves are still hot with the dry blend composition to build a skin on the entire inner surface that will melt on contact with the rotomold inner surface and a plastic outer shell that exhibits a pearly appearance of the golden interference pigment as well as the blue color of the inorganic coloring pigment is created.

The mold is then be filled with an uncolored rotomolding grade polyethylene (Novapol® TR-0735-U Hexene MDPE, product of NOVA Chemicals®, Canada).

Afterwards, the mask or tape is removed from the flange and the rotomold is closed and bolt together.

After the rotomold is closed, a usual rotomolding procedure is started, comprising heating the rotomold to about 200° C., rotating the rotomold in a usual manner and cooling the rotomold while further having it rotated, until the inner layer of the hollow plastic article is created. After appropriate cooling, the ready hollow plastic particle may be removed from the open rotomold. Since the inorganic coloring pigment contained in the outer shell applies an opaque appearance thereto, the colorless inner layer of the hollow plastic article may not be observed when the outer surface of the product is evaluated. Instead, the blue color of the inorganic coloring pigment as well as the golden pearlescent effect which is due to the content and the proper surface orientation of the platelet-shaped pearlescent pigment in the outer shell may be observed.

### EXAMPLE 2

An open 2 part metal rotomold is pre-heated to a temperature of about 200° C. at targeted areas of the inner surface thereof by flame treatment of the corresponding areas.

A mixture of 2% by weight an interference pearl pigment (Pyrisma® T 30-23 Color Space Blue, product of Merck KGaA, Germany) and 98% by weight of a polyethylene powder (Novapol® TR-0735-U Hexene MDPE, product of NOVA Chemicals®, Canada) is dry blended and filled into a standard powder coating gun.

Both halves of the hot rotomold are hung in a powder coating spray booth immediately after the heat treatment. A mask or a tape is applied onto the flanges of the open halves of the rotomold.

Afterwards, the inside surface of the pre-heated rotomold halves is sprayed by means of the powder coating gun with the dry blend composition, whereby a skin is built only at the pre-heated areas of the inner surface of the rotomold that will melt on contact with these parts of the rotomold inner surface and a transparent layer that exhibits a soft pearly appearance and the bluish interference color of the interference pearl pigment is created on the targeted areas of the inner surface of the rotomold when the rotomold is cooled.

The mold is then be filled with an colored rotomolding grade polyethylene (Novapol® TR-0735-U Hexene MDPE, product of NOVA Chemicals®, Canada) containing 0.2% by weight, based on the weight of the mixture of polyethylene and pigment, of a red colored absorption pigment. Afterwards, the mask or tape is removed from the flange and the rotomold is closed and bolt together.

Subsequently, a usual rotomolding procedure is started, comprising heating the rotomold to a temperature of about 200° C., rotating the rotomold in a usual manner and cooling the rotomold while further having it rotated, until the inner layer of the hollow plastic article is created. After appropriate cooling, the ready hollow plastic particle may be removed from the open rotomold.

The resulting hollow plastic article exhibits on the targeted areas of the exterior surface thereof a pearlescent appearance with a bluish interference color, whereas the red color of the coloring pigment contained in the inner layer of the resulting hollow article may be observed throughout the exterior surface of the resulting product, at the targeted areas mixed with the blue interference color and the pearly gloss of the interference pigment.

1. Process for the production of hollow plastic articles by rotational molding polymeric compounds in a rotomold, characterized by the following steps:
A) forming a colored outer shell of a hollow plastic article in a stationery open rotomold having an inner surface, by applying a colored polymer particulate composition comprising a first polymer and coloring pigments to the inner surface of the rotomold,
B) charging a rotomolding polymer composition comprising a second polymer into the rotomold,
C) closing the rotomold, and
D) processing a rotomolding procedure by rotating the rotomold, thereby forming an inner layer of the hollow plastic article.

2. Process for the production of hollow plastic articles according to claim 1, wherein the inner surface of the rotomold in step A) exhibits a temperature which is at or above the glass transition temperature of the first polymer.

3. Process according to claim 1 or 2, wherein the colored polymer particulate composition in step A) comprises platelet-shaped effect pigments as coloring pigments.

4. Process according to one or more of claims 1 to 3, wherein the colored polymer particulate composition in step A) additionally comprises additives and/or further non platelet-shaped coloring pigments.

5. Process according to claim 3, wherein the platelet-shaped effect pigments are selected from the group consisting of metal effect pigments, pearlescent pigments and interference pigments.

6. Process according to one or more of claims 1 to 5, wherein the colored polymer particulate composition in step A) is applied to the inner surface of the rotomold by means of a spraying process.

7. Process according to claim 6, wherein the spraying process is executed by means of a powder coating gun.

8. Process according to one or more of claims 1 to 7, wherein the first polymer is composed of one or more selected from the group consisting of polyethylenes, polyvinylchlorides, polycarbonates, nylons, polypropylenes, polystyrenes, polyurethanes, epoxy resins and phenolic resins, or of mixtures or copolymers of two or more of these polymers.

9. Process according to one or more of claims 1 to 8, wherein the first polymer and the second polymer are of the same chemical composition.

10. Process according to one or more of claims 1 to 9, wherein the rotomolding procedure in step D) is carried out at a temperature of the rotomold at or above the glass transition temperature of the second polymer.

11. Hollow article being composed of a colored outer shell and an inner layer which are inseparably connected to each other, wherein the hollow article is produced by a process according to one or more of claims 1 to 10.

12. Hollow article according to claim 11, wherein the colored outer shell comprises platelet-shaped effect pigments.

13. Hollow article according to claim 12, wherein the colored outer shell has an outer surface exhibiting a metallic or pearlescent optical behavior.

14. Hollow article according to one or more of claims 11 to 13, wherein the inner layer does not contain platelet-shaped effect pigments.

15. Hollow article according to one or more of claims 10 to 14, wherein the hollow article is a tank, a means for transportation, a container, a toy or a leisure article, a product for materials handling, a product for the marine industry, a medical product or an industrial product.
